(19) United States
(12) Patent Application Publication
(10) Pub. No.: US 2010/0077147 A1
(43) Pub. Date: Mar. 25, 2010

(54) METHODS FOR CACHING DIRECTORY STRUCTURE OF A FILE SYSTEM

(75) Inventor: Jung-Chih LIU, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/233,870

(22) Filed: Sep. 19, 2008

(51) Int. Cl. G06F 12/08

(52) U.S. Cl. 711/126; 711/E12.017

(57) ABSTRACT

A file system cache method for a device accessing a file system is provided, wherein the device has a processing unit and a cache buffer. The method comprises accessing a folder in the file system, caching information of child folders of a currently accessed folder when accessing a root folder, caching information of parent folders of the current accessed folder when accessing a leaf folder, caching information of at least one parent folder and at least one child folder of the currently accessed folder when accessing a child folder not classified as a leaf folder, and removing cache buffer entries of sibling folders of the currently accessed folder.

### BACKGROUND OF THE INVENTION

1. Field of the Invention

The invention relates to file system caching, and more precisely, to methods for caching directory structure of a file system.

2. Description of the Related Art

For current computer systems, external storage devices, such as optical disc drives, USB flash devices, or memory cards are frequently utilized for data storage. The access speeds of the external storage devices are typically much slower than that of the computer internal memory or hard disk drive.

Generally, to increase the file browsing speed for a host or computer system browsing an external storage device, a cache buffer is utilized by the computer system to store the directory structure of the file system for fast file browsing. This cache buffer speeds up file browsing and disk scanning operations by avoiding the delay caused by re-accessing the external storage device for acquiring the directory structure.

A method for browsing the directory structure of the file system having a plurality of folders is to cache information (e.g. physical address) of all folders in the directory structure of the file system into a cache buffer. This method, however, requires a large-sized cache buffer and can not be applied to systems having limited cache buffer sizes. For a system having a limited cache buffer size, the cache buffer may not be able to store a complete directory structure.

There is a tradeoff between the additional cache buffer and the speed of file browsing and disk scanning.

### BRIEF SUMMARY OF THE INVENTION

An embodiment of the invention provides a file system cache method which requires less cache buffer size while keeping high cache hit rate. The file system having M folders is accessed by a processing unit utilizing a cache buffer. The method comprises the following steps. First, one of the M folders is accessed. Then, information of parent folders and child folders of the currently accessed folder are cached into the cache buffer, wherein the number of the cached buffer entries is less than the number of folders M. When the processor accesses a child folder not belonging to a leaf folder, child folders of the currently accessed folder is cached in the cache buffer while the cache buffer entry of sibling folders of the currently accessed folder are removed from the cache buffer.

An embodiment of the invention also provides a scan method for performing a disk scan procedure to obtain a disk scan result of the file system. A processor scans the file system of a storage medium with a cache buffer. The scan method comprises the following steps. First, a root folder is accessed for obtaining information such as a number of files. The child folders of the root folder are cached in the cache buffer. Then, the processor subsequently accesses each of the child folders for obtaining information for disk scan result so that a next child folder (e.g. sibling of current child folder) of the root folder is accessed when all leaf folder(s) of the current child folder (e.g. the first child folder) have been accessed. Information of sibling folder(s) of a currently accessed folder is removed from the cache buffer while information child folder(s) of the currently accessed folder are added into the cache buffer. Consequently, information of the parent folder(s) and child folder(s) of the currently accessed folder, together with the currently accessed folder, are cached in the cache buffer, wherein the number of the cache buffer entries is always less than the total number of folders in the storage medium. The disk scan procedure is complete when all the folders in the storage medium are accessed and the disk scan result is retrieved.

An embodiment of the invention further provides a device for caching a directory structure of a file system. The device comprises a cache buffer and a processing unit for accessing folders of the file system to obtain disk scan result. The cache buffer stores data of a selected portion of the folders in the file system. The cache buffer caches data of predetermined folders and removes at least data of sibling folder(s) of a currently accessed folder. The predetermined folders include a root folder and child folders of the root folder if the currently accessed folder is the root folder. The predetermined folders include sibling and parent folders of a leaf folder when the currently accessed folder is the leaf folder. Otherwise, the predetermined folders include a currently accessed folder, all lineal parent folder(s), and child folder(s) for one level.

### BRIEF DESCRIPTION OF THE DRAWINGS

The invention can be more fully understood by reading the subsequent detailed description and examples with reference to the accompanying drawings, wherein:

FIG. 1 shows an embodiment of a device for caching a directory structure of a file system;

FIG. 2A shows an example of a directory structure of a file system;

FIG. 2B shows an example of a data format of a cache buffer entry;

FIG. 2C shows an example of folder information of the directory structure of FIG. 2A;

FIG. 2D shows an example of a data format of folder information of the directory structure of FIG. 2A;

FIG. 3 is a flowchart of a method for caching a directory structure of a file system;

FIG. 4 is a flowchart of a scan method for performing a disk scan procedure to obtain a directory structure of a file system;

FIG. 5A-5D show examples of cached data in the cache buffer corresponding to the method of FIG. 4; and

FIG. 6 shows a detailed operation of an embodiment of the disk scan procedure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

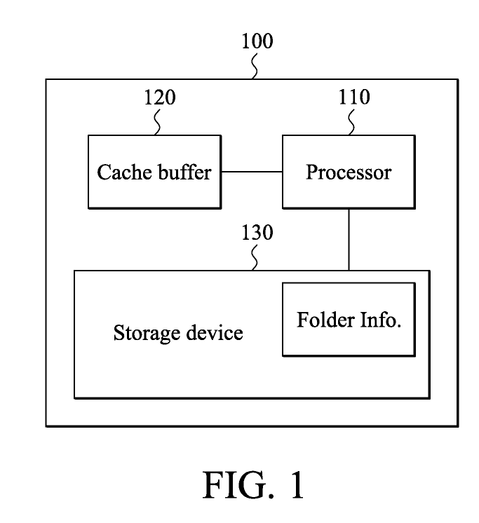

The invention will now be described with reference to FIGS. 1 through 6, which generally relate to methods for caching a directory structure of a file system and applying the method to perform a disk scan procedure. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

The embodiments of the invention provide methods for caching a directory structure of a file system and applying the method to perform a disk scan procedure so as to quickly perform the disk scanning and provide higher cache hit rate.

FIG. 1 shows an embodiment of a system 100 for caching a directory structure of a file system in a storage device 130 according to the invention. The system 100 comprises a processor 110, a cache buffer 120 and the storage device 130. The storage device 130 (e.g. hard disk, flash memory, or external storage device) stores folders and folder information of a directory structure such as folder identity, parent folder and child folders. The cache buffer 120 caches data related to the directory structure of the file system to try to avoid repeatedly retrieving the same data from the storage device, for example, the cache buffer 120 caches the logical block address (LBA) of a parent folder and child folder(s) of a currently accessing folder. It is to be noted that while the cache buffer 120 of the embodiment is connected to the processor 120, the cache buffer 120 may be, in another embodiment, disposed inside of the processor 120 or the storage device or the like.

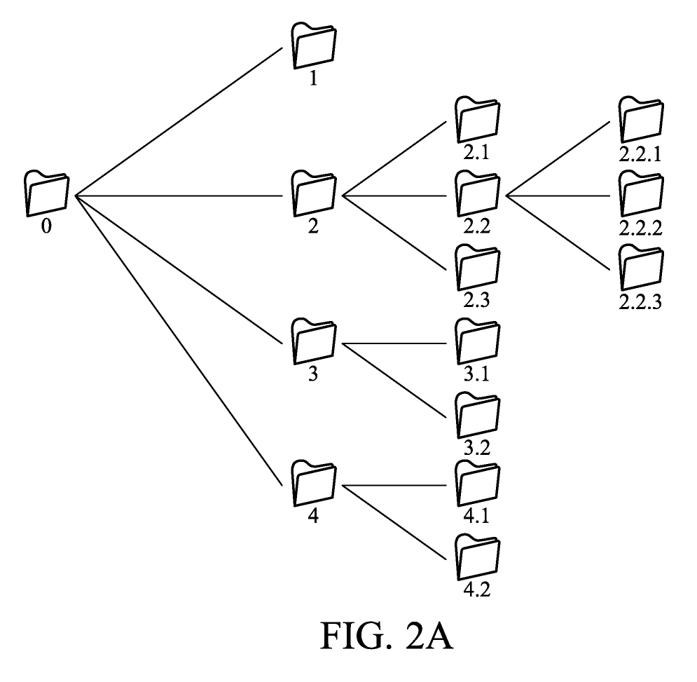

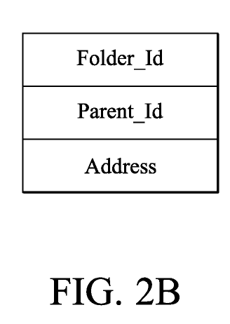

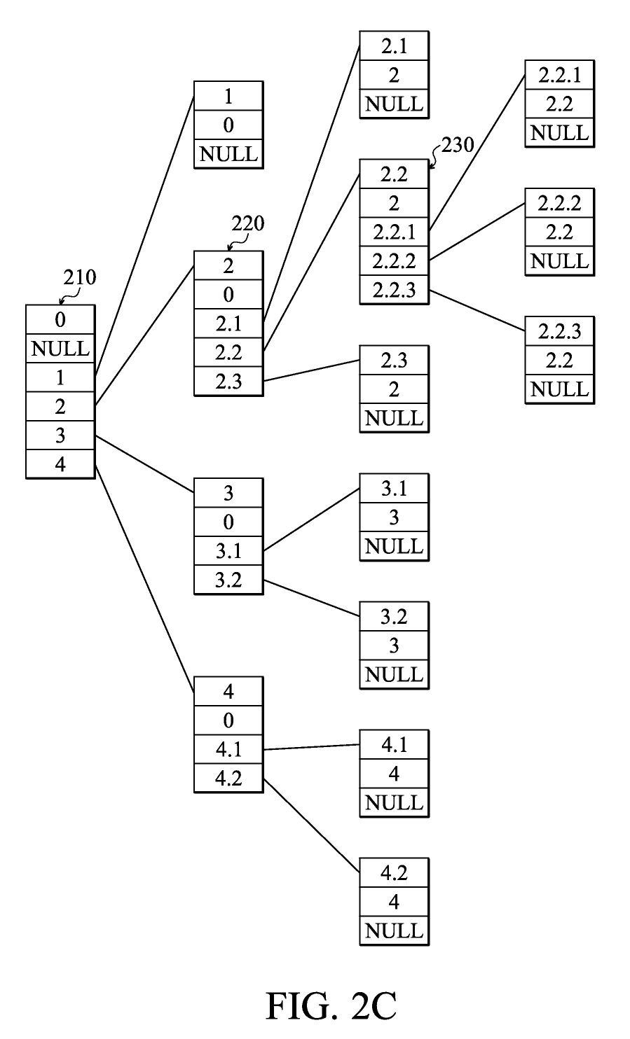

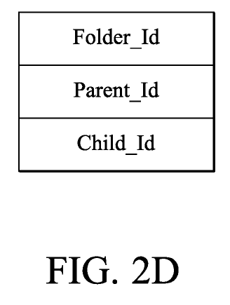

FIG. 2A shows an example of a directory structure of a file system stored in a storage device. The file system 131 comprises a total of M folders (e.g. 15 folders in this example), arranged in N layers (e.g. 4 layers in this example). A folder is referred to as a root folder if it has no parent folder while a folder is referred to as a leaf folder if it has no child folder. For example, folder entry 0 is a root folder while folder entries 2.2.1, 2.2.2 and 2.2.3 are leaf folders. Sibling folders are those having a parent folder which is the same as the selected folder, or so called the currently access folder. For example, if the folder entry 2.2 is selected, its parent folder is folder entry 2, its child folders are folder entries 2.2.1, 2.2.2 and 2.2.3 and its sibling folders are folder entries 2.1 and 2.3 (since the parent folder of these entries is the same (i.e. folder entry 2)). FIG. 2B shows an example of a data format of a cache buffer entry. The cache buffer temporally buffers information related to the directory structure for fast folder accessing. For the example shown in FIG. 2B, each cache buffer entry has a field Folder_Id representing an identity number of a particular folder, a field Parent_Id representing an identity number of a parent folder of the particular folder, and a field Address representing a physical address storing the particular folder in the storage device.

FIG. 2C shows an example of folder information of the directory structure of FIG. 2A physically stored in the storage device 130. FIG. 2D shows an example of a data format of folder information for each folder in FIG. 2A. For the data format of FIG. 2D, each folder of FIG. 2A has a corresponding folder information stored in the storage device 130. The folder information of FIG. 2D has a field Folder_Id representing an identity number of a selected folder entry, a field Parent_Id representing an identity number of the parent folder of the selected folder entry and a field Child_Id representing all child folder entries of the selected folder entry. The folder information corresponding to the directory structure of FIG. 2A are shown in FIG. 2C, and a label “NULL” represents that there is lack of a parent folder (e.g. folder entry 0) or a child folder (e.g. folder entry 2.2.1, 2.2.2 or 2.2.3).

A directory structure of the file system (e.g. FIG. 2A) can be obtained by referring to the related folder information (e.g. FIG. 2C). A disk scan procedure can be performed by the processor 110 to obtain a disk scan result of the file system by referring to the folder information. For example, the processor performs disk scan procedure to count the total number of files stored in the storage device 130 when the user selects the link and wishes to read data stored in the storage device 130. To consider both the cache buffer size and the speed of file browsing, a cache method is applied to the cache buffer 120 for dynamically selecting data needed to be cached.

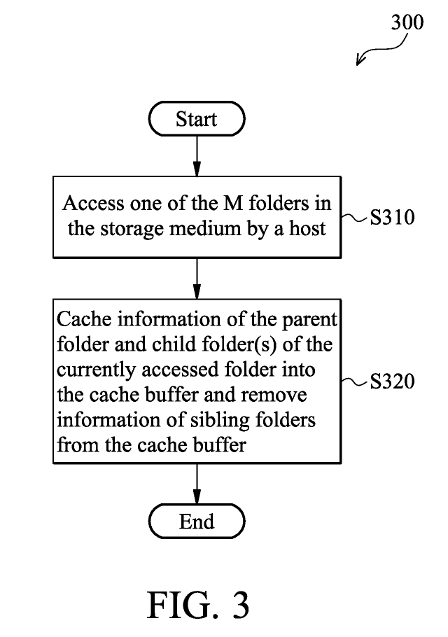

FIG. 3 is a flowchart of a cache method 300 for caching a directory structure of a file system. In this embodiment, it is assumed that the file system having M folders and together with related folder information of the M folders are stored in a storage medium (e.g. storage device 130). First, one of the M folders in the storage medium, such as folder entry 0 is accessed by a host (step S310). In some embodiment, only information related to the root folder (i.e. folder entry 0 in FIG. 2C) is initially put into the cache buffer 120. For information temporally stored in the cache buffer, please refer to FIG. 2B for an exemplary data format of a cache buffer entry. When a folder is accessed, information such as the logical block addresses (LBA) of the parent folder and child folder(s) of the currently accessed folder (i.e. folder entry 0) are cached into the cache buffer, and information of sibling folders are removed from the cache buffer (step S320). Note that the number of cache buffer entries in the cache buffer at any time is less than the total number of folders (M). In other words, the cache buffer caches information of a portion of the M folders. For example, in this embodiment, cache buffer entries of folder entries 1, 2, 3 and 4 are added into the cache buffer if the currently accessed folder is folder entry 0 to make the cache buffer stores cache buffer entries 0, 1, 2, 3, and 4. In another example, when folder 2 is selected, the cache buffer only keeps information of folder entries 0 and 2, and acquires information of child folder entries of folder 2, folder entries 2.1, 2.2, and 2.3. The cache method caches information such as the logical block address (LBA) of only the parent folder(s) and child folder(s) of a currently accessed folder, and by having information of all the child folder entries stored in the cache buffer, the processor promptly obtains the LBA of the child folder from the cache buffer for accessing the folder contents in the storage medium. The processor may also access the folder contents of the parent folder according to the LBA of the parent folder cached in the cache buffer.

In this embodiment, data cached in the cache buffer 120 will be dynamically determined and changed in response to a newly selected folder. The cached data in the cache buffer is dynamically changed when entering into another folder of the M folders other than the currently entered folder. When entering into one of the child folders, information of sibling folders of the entered child folder are removed from the cache buffer 120 and information of the child folders of the entered child folder are added into the cache buffer 120. For example, referring to FIG. 2C, when entering into folder entry 230 (i.e. folder entry 2.2), information the sibling folders of folder entry 2.2, i.e. folder entries 2.1 and 2.3, are removed from the cache buffer and replaced with information of child folders of folder entry 2.2, i.e. folder entries 2.2.1, 2.2.2 and 2.2.3. Therefore, data cached in the cache buffer 120 are related to parent folders (folder entries 2 and 0) and child folders (folder entries 2.2.1, 2.2.2 and 2.2.3) of the entered folder entry 2.2.

Information of the parent folders and child folders of the currently entered folder are selectively cached into the cache buffer according to a predefined rule. For example, information of the parent folders and child folders of the currently entered folder are selectively cached into the cache buffer 120 according to a buffer size of the cache buffer 120. Buffer overflow may be prevented by dynamically removing one or more cache buffer entry of the parent folder of upper layers, for example, removing information of the root folder (first layer) and then the parent folder of the second, third, fourth . . . layers sequentially when the exploring folder path becomes deeper and deeper. In another embodiment, when the number of subfolders exceeds the cache buffer size, the cache buffer may be controlled to only buffer a limited number of subfolders at a time, for example, caching 50 out of 100 child folders.

During a disk scan procedure, each of the M folders is sequentially visited for retrieving information such as the total number of files in the M folders. When all of the leaf folders belong to one folder (e.g. leaf folders 2.2.1, 2.2.2, and 2.2.3 belongs to folder 2.2) have been visited, the cache buffer entry the visited leaf folders are removed from the cache buffer 120 and the procedure returns back to the parent folder of the folder (e.g. folder entry 2) and the cache buffer entry of child folders of the returned folder are added into the cache buffer 120 (e.g. folder entry 2.1, 2.2, and 2.3).

When folder entry 2.3 is visited, it returns to the root folder (folder entry 0) once again, and the cache buffer 120 caches information of folder entries 0, 1, 2, 3, and 4. Folder entry 3 is then accessed with a similar manner.

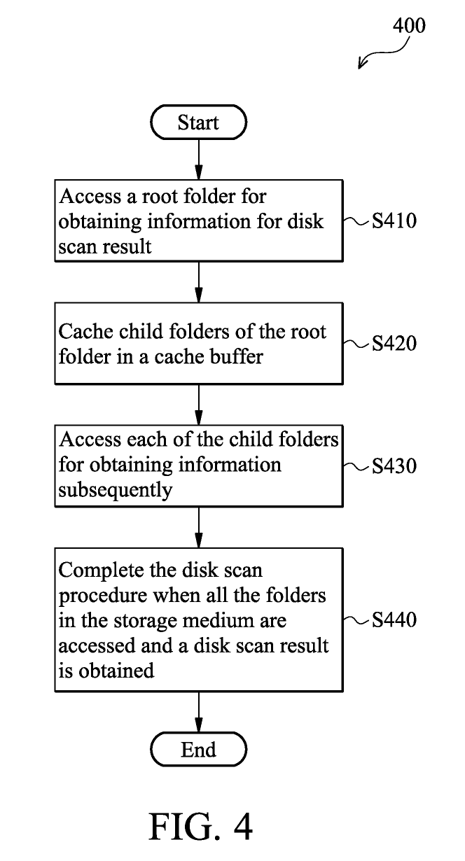

FIG. 4 is a flowchart of a scan method 400 for performing a disk scan procedure to obtain information of the file system in a storage medium. When the disk scan procedure is started, in step S410, a root folder is access for obtaining information for disk scan result, where the disk scan result may be one or a combination of a counting of total number of files in the file system, a data size, a search result for a particular file or a type of files, or a search result for any kind of file system attributes, etc. In step S420, child folders of the root folder are cached in a cache buffer. In step S430, each of the child folders is accessed for obtaining information subsequently. A next child folder (e.g. the second child folder) of the root folder is accessed when all leaf folder(s) of a current child folder (e.g. the first child folder) of the root folder have been accessed. Information (such as address) of sibling folder(s) of a currently accessed folder is removed from the cache buffer while information (such as address) of child folder(s) of the currently accessed folder is added into the cache buffer. Consequently, information of the parent folder(s) and child folder(s) of the currently accessed folder, together with information of the currently accessed folder, are cached in the cache buffer, wherein the number of the cache buffer entries in the cache buffer at anytime is less than the total number of folders in the storage medium. In step S440, the disk scan procedure is complete when all the folders in the storage medium are accessed and a disk scan result is obtained.

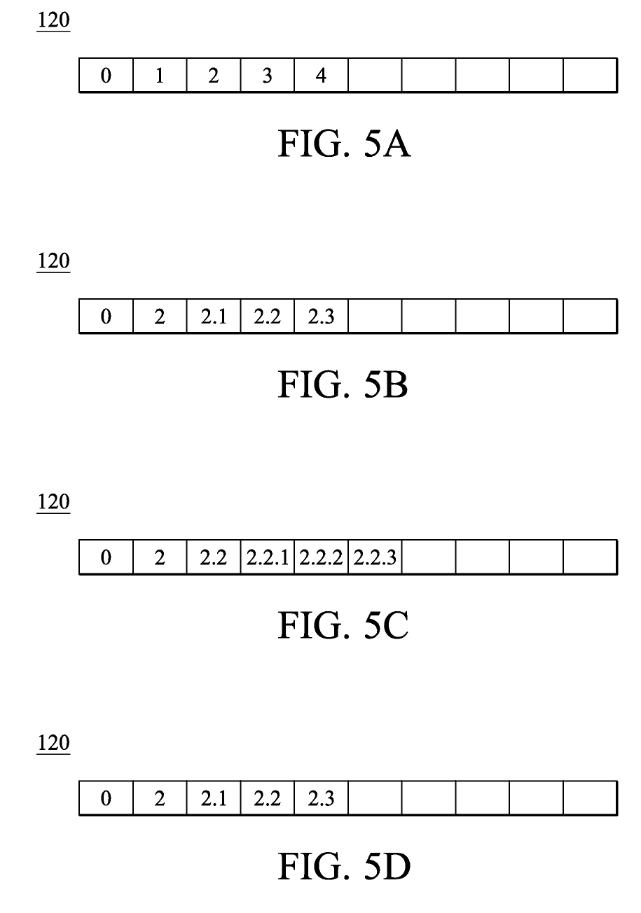

FIGS. 5A-5D show examples of cache buffer entries in the cache buffer corresponding to the directory structure shown in FIG. 2A. FIG. 5A shows the cache buffer entries in the cache buffer when folder 0, the root folder, is selected. FIG. 5B shows the cache buffer entries when folder 2, a child folder of folder 0, is selected. FIG. 5C shows the cache buffer entries when folder 2.2, a child folder of folder 2, is selected, and FIG. 5D shows the cache buffer entries when returning to folder 2 from folder 2.2.

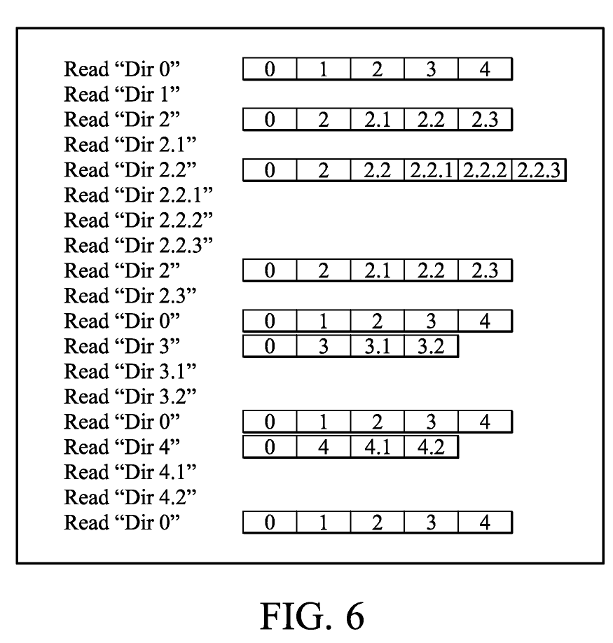

FIG. 6 shows a detailed operation of an exemplary disk scan procedure corresponding to the directory structure shown in FIG. 2A. At the beginning, a root directory will firstly be entered or browsed. When browsing the root directory, the root folder (folder 0) is read and information of child folders of the root directory is obtained. Information of the four child folders are then put into the cache buffer 120 as cache buffer entries. Thereafter, the four child folders are sequentially visited and entered. When entering folder entry 1, no additional data requires to be cached into the cache buffer 120 since folder entry 1 is a leaf folder. After folder entry 1 has been entered, folder entry 2 is then entered. When entering the folder 2, the cache buffer entry of the sibling folders of folder 2 (i.e. folder entries 1, 3 and 4) are removed from the cache buffer 120 and information of the child folders of folder 2 (i.e. folder entries 2.1, 2.2 and 2.3) are added into the cache buffer 120. Similarly, each child folder of the folder entry 2 is sequentially visited and entered. Folder 2.1 is a leaf folder, so no additional data requires to be cached when entering folder 2.1. When entering folder 2.2, the cache buffer entry of the sibling folders of folder 2.2 (i.e. folder entries 2.1 and 2.3) are removed from the cache buffer 120 and information of the child folders of folder 2.2 (i.e. folder entries 2.2.1, 2.2.2 and 2.2.3) are added into the cache buffer 120. The cache buffer entries in the cache buffer are now corresponding to folder entries 0, 2, 2.2, 2.2.1, 2.2.2, 2.2.3. Then, the cache buffer entry of the child folders of folder 2.2 (i.e. folder entries 2.2.1, 2.2.2 and 2.2.3) are sequentially entered. After all folder entries 2.2.1, 2.2.2 and 2.2.3 are visited, the procedure accordingly returns to access the parent folder, i.e. folder entry 2.2, of the visited child folder, and back to folder 2. The cache buffer entry of the visited folders 2.2.1, 2.2.2 and 2.2.3 are thus removed from the cache buffer 120 and information of the child folders of folder 2 (i.e. folder entries 2.1 and 2.3) are again added into the cache buffer 120. The last child folder of folder 2, folder 2.3, is then visited. Since all subfolders belong to folder 2 are visited, the root folder is once again accessed and the cache buffer entries in the cache buffer become folder entries 0, 1, 2, 3, and 4. Then folder 3 and its child folders, folder 4 and its child folders are sequentially entered, and the change in cache buffer entries when accessing each of the folders is illustrated in FIG. 6. The disk scan procedure is completed when all of the folders are visited and a desired disk scan result is retrieved.

An advantage of embodiments of the cache method is that, because the data cached in the cache buffer are limited and dynamically determined, the buffer size can be reduced and the cache method can be applied when a small-sized cache buffer is used. Another advantage of the embodiment is that, a high hit rate can be achieved as the cached data are dynamically determined according to the currently accessed folder information and are most likely to be used for later accessing. Therefore, the present invention provides a compromise solution between accessing by caching all folder entries and accessing without caching.

In some embodiments, the cache buffer entry of the sibling folders may be remained in the cache buffer until the cache buffer is nearly overflowed. There might be a predetermined threshold and the number of entries in the cache buffer is being monitored, once the number of entries reaches the predetermined threshold, some or all of the cache buffer entries of the sibling folders are removed from the cache buffer. This embodiment further reduces the folder access time as the cache hit rate will be increased with more cache buffer entries in the cache buffer. In another embodiment, the cache buffer entries of the reserved root folder and some of the parent folders other than the parent folder of a selected folder may be removed from the cache buffer dynamically when the available cache buffer size is not enough for caching all child folders of the selected folder. In another embodiment, the number of the cache buffer entries of child folders cached at a time can be limited when the number of the child folders exceeds the capacity of the cache buffer.

The described embodiments of methods for caching a directory structure of a file system and applying the method to perform a disk scan procedure, or certain aspects or portions thereof, may be practiced in logic circuits, or may take the form of a program codes (i.e., instructions) embodied in tangible media, such as optical discs, hard drives, or any other machine-readable storage medium, wherein, when the program codes are loaded into and executed by a machine, such as a computer, a digital camera, a mobile phone, or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor, the program codes combine with the processor to provide a unique apparatus that operate analogously to specific logic circuits.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A file system cache method for a device accessing a file system having M folders, wherein the device comprises a processing unit and a cache buffer, the method comprising:
accessing one of the M folders;
caching information of a plurality of child folder of a currently accessed folder into the cache buffer when accessing a root folder, wherein the root folder has no parent folder;
caching information of a plurality of parent folders of the currently accessed folder into the cache buffer when accessing a leaf folder; wherein the leaf folder has no child folder;
caching information of at least one parent folder and at least one child folder of the currently accessed folder into the cache buffer when accessing a child folder not classified as a leaf folder; and
removing a cache buffer entry of a sibling folder of the currently accessed folder from the cache buffer; wherein the sibling folder has a parent folder which is the same as the currently accessed folder.

2. The method of claim 1, wherein the information cached in the cache buffer as cache buffer entries includes a logical block address (LBA).

3. The method of claim 1, further comprising:
sequentially accessing each of M folders in an order of accessing a child folder prior to a sibling folder of the currently accessed folder;
obtaining a disk scan result after accessing all the M folders.

4. The method of claim 3, further comprising:
removing cache buffer entries of child folders of a particular folder from the cache buffer when all of the child folders have been visited;
returning to the parent folder of the particular folders; and
caching information of child folders of the returned folder into the cache buffer.

5. The method of claim 4, wherein the disk scan result comprises one or a combination of total number of files in the file system, a data size, a search result for a particular file, a search result for a type of files, or search result for any kind of file system attributes.

6. The method of claim 1, further comprising selectively caching information of a portion of the child folders of the currently accessed folder into the cache buffer according to a predefined rule.

7. The method of claim 6, further comprises caching information of a portion of the child folders depending on a buffer size of the cache buffer.

8. The method of claim 1, further comprising selectively removing one or more cache buffer entries of the parent folders of the currently accessed folder from the cache buffer according to a predefined rule.

9. The method of claim 8, further comprises removing one or more cache buffer entries of the parent folders depending on a buffer size of the cache buffer.

10. A scan method for performing a disk scan procedure to obtain a disk scan result by accessing a file system by a device having a processor and a cache buffer, the scan method comprising:
accessing a root folder for obtaining information for disk scan result;
caching information of child folders of the root folder into the cache buffer;
subsequently accessing each of the child folders of the root folder for obtaining information for disk scan result, wherein a next child folder of the root folder is accessed when all leaf folders of a current child folder of the root folder have been accessed;
caching information of child folders of the currently accessed folder and removing a cache buffer entry of a sibling folder of the currently accessed folder, wherein the sibling folders have a parent folder which is the same as the entered child folder; and
obtaining disk scan result of the file system when all folders are accessed.

11. The method of claim 10, further comprising:
sequentially accessing each folder in an order of accessing a child folder prior to a sibling folder of the currently accessed folder.

12. The method of claim 10, further comprising:
removing cache buffer entries of child folders of a particular folder from the cache buffer when all of the child folders have been visited;
returning to the parent folder of the particular folders; and
caching information of child folders of the returned folder into the cache buffer.

13. The method of claim 10, wherein the disk scan result comprises one or a combination of total number of files in the file system, a data size, a search result for a particular file, a search result for a type of files, or a search result for any kind of file system attribute.

14. The method of claim 10, further comprising selectively caching information of a portion of the child folders of the currently accessed folder into the cache buffer according to a predefined rule.

15. The method of claim 10, further comprising selectively removing cache buffer entries of the parent folders of the currently accessed folder from the cache buffer according to a predefined rule.

16. A device for accessing a file system, comprising:
a cache buffer, caching information of folders in the file system as cache buffer entries; and
a processor, accessing the file system by referring to the cache buffer entries in the cache buffer,
wherein the cache buffer caches child folders of a currently accessed folder and the processor removes sibling folders of the currently accessed folder when accessing a folder in the file system, and the sibling folder has a parent folder which is the same as the currently accessed folder.

17. The device of claim 16, wherein the cache buffer entries in the cache buffer are dynamically changed when entering into another folder.

18. The device of claim 16, wherein the cache buffer caches the child folders and the processor removes the sibling folders when accessing a folder not classified as a root folder nor a leaf folder, the root folder has no parent folder, and the leaf folder has no child folder.

19. The device of claim 16, wherein the cache buffer entry cached in the cache buffer includes a logical block address (LBA).

20. The device of claim 16, wherein the cache buffer selectively caches information of a portion of the child folders of the currently accessed folder into the cache buffer according to a predefined rule.
